(19) United States
(12) Patent Application Publication
(10) Pub. No.: US 2012/0166552 A1
(43) Pub. Date: Jun. 28, 2012

(54) Managing Messaging Subscriptions in a Messaging System

(76) Inventors: Joel Benjamin Seligstein, Mountain View, CA (US); Michael David Adkins, Sunnyvale, CA (US)

(21) Appl. No.: 12/978,276

(22) Filed: Dec. 23, 2010

(51) Int. Cl. G06F 15/16

(52) U.S. Cl. 709/206

(57) ABSTRACT

A messaging system for managing messaging subscriptions. A messaging provider receives a request to subscribe a user's message account to a subscription system. The messaging provider associates the subscription system with the user's message account to indicate to the messaging provider that the user has subscribed to receive messages from the subscription system. The messaging provider also communicates an identifier for the message account to the subscription system, which is used by the subscription system in sending messages to the user's message account. By subscribing to receive messages from subscription systems via the messaging provider in this manner, the messaging provider is automatically notified of the subscription systems that a user has subscribed to, enabling the messaging provider to more accurately determine how incoming messages should be handled.

### BACKGROUND

This invention relates generally to messaging systems, and more specifically to a messaging system for managing messaging subscriptions.

Messaging providers, such as email providers, receive and store messages intended for electronic mail (“email”) accounts hosted by the provider. Incoming messages are often processed to identify unwanted messages, for example, by applying spam filters to the incoming messages. Messages deemed to be of little importance are blocked or placed in a spam folder, whereas other messages are allowed to appear into a user's inbox. However, spam filters are imperfect and will often generate false positives. In other words, some messages may be erroneously marked as spam when in reality they are important messages.

Messages received from subscription systems, such as subscription based websites, are particularly susceptible to this problem. A subscription based website receives email addresses from its users, which enables the website to send messages, such as news updates or confirmations for activities performed on the website, to its users using the supplied email addresses. There are numerous examples of subscription based websites including shopping websites, bank websites, online discussion forums, etc. Conventional spam filters have a difficult time determining whether messages from these websites should be marked as spam. As a result, many of these messages, which can include important information such as bank statements and phone bills, are mistakenly blocked by the spam filters and are never delivered to their intended recipients.

### SUMMARY

Embodiments of the invention include a system for subscribing to receive messages from a subscription system via a messaging provider. In this way, the messaging provider is automatically notified of the subscription systems that a user has subscribed to, enabling the messaging provider to more accurately determine how incoming messages should be handled.

In one embodiment, the messaging system includes a user device, a subscription system, and a messaging provider. A user of the user device interacts with the subscription system, such as by accessing a uniform resource locator (“URL”) hosted by the subscription system or selecting a subscription action displayed on a web page received from the subscription system. The messaging provider, which hosts the user's message account, receives a request to subscribe the user's message account to the subscription system. The messaging provider associates the system with the user's message account to indicate to the messaging provider that the user has subscribed to receive messages from the subscription system. The messaging provider also communicates an account identifier for the message account to the subscription system, which is used by the subscription system in sending messages to the user's message account. For example, the account identifier can be an email address associated with the user's message account.

This process may be repeated a number of times, resulting in a rich knowledgebase of information about the subscription systems that each message account is subscribed to. In addition, the knowledgebase is automatically and continuously updated as users subscribe to receive messages from new systems. Having this information enables the messaging provider to better determine how to handle incoming messages based on whether a user has subscribed to receive messages from the sender of the message, which is beneficial for all entities in the messaging system. The subscription system benefits because its outgoing messages are no longer at risk of being improperly blocked by the messaging provider. The user benefits because the user's incoming messages from the subscription system are no longer at risk of being improperly blocked by the messaging provider. The messaging provider also benefits because it simplifies the task of processing incoming messages.

### BRIEF DESCRIPTION OF THE DRAWINGS

FIG. 1 is a high-level block diagram of a messaging system for managing messaging subscriptions, according to one embodiment.

FIG. 2 is a screenshot of a web page for subscribing to a website via a messaging provider, according to one embodiment.

FIG. 3 is an interaction diagram of a process for managing messaging subscriptions, according to one embodiment.

FIG. 4 is an interaction diagram of a process for managing messaging subscriptions, according to another embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Configuration Overview

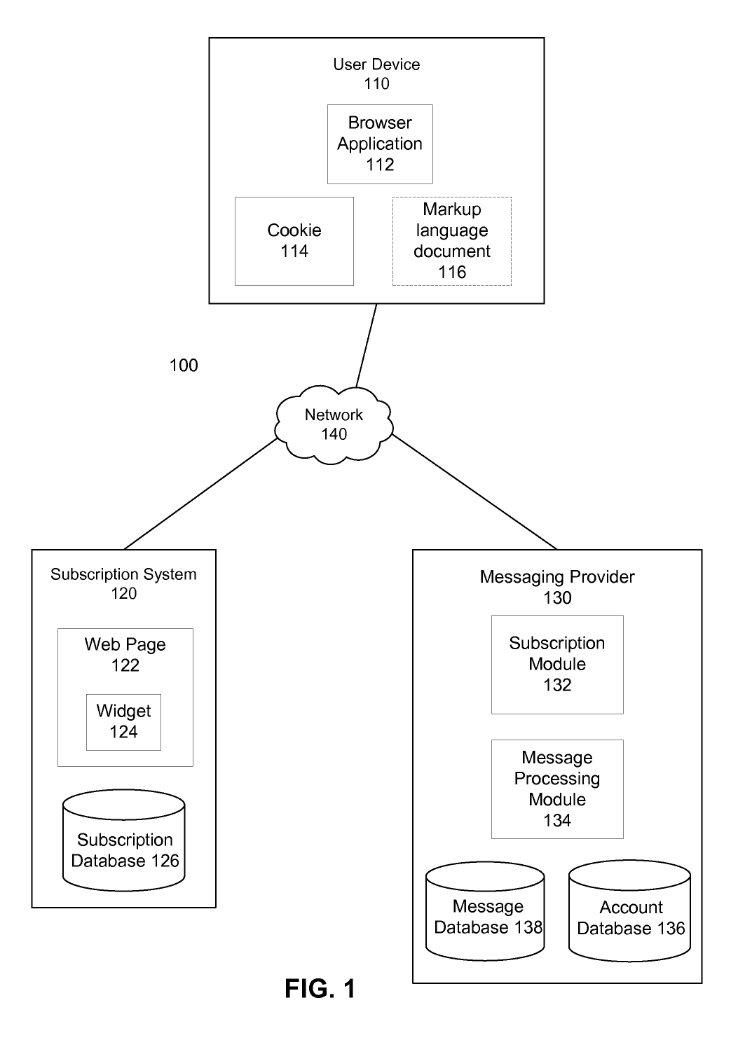

FIG. 1 is a high-level block diagram of a messaging system 100 for managing messaging subscriptions according to one embodiment. The system 100 includes a user device 110, subscription system 120, a messaging provider 130, and a network 140. For purposes of illustration, the embodiment of the system 100 shown by FIG. 1 includes a single subscription system 120 and a single user device 110. However, in other embodiments, the messaging system 100 may include more user devices 110, subscription systems 120, or messaging providers 130.

The user device 110 comprises one or more computing devices that can receive input from a user and can transmit and receive data via the network 140. For example, the user device 110 may be a desktop computer, a laptop computer, a smart phone, a personal digital assistant (PDAs) or any other device including computing functionality and data communication capabilities. The user device 110 is configured to communicate with the subscription system 120 and the messaging provider 130 via the network 140, which may comprise any combination of local area and/or wide area networks, using both wired and wireless communication systems.

In one embodiment, the user device 110 displays content from the subscription system 120 or from the messaging provider 130 by processing a markup language document 116 received from the subscription system 120 or from the messaging provider 130 using a browser application 120. The markup language document 116 identifies content and one or more instructions describing formatting or presentation of the content. By executing the instructions included in the markup language document 116, the browser application 112 displays the identified content using the format or presentation described by the markup language document 116. For example, the markup language document 116 includes instructions for generating and displaying a web page having multiple frames that include text and/or image data retrieved from the subscription system 120 and/or the messaging provider 130. In various embodiments, the markup language document 116 comprises a data file including extensible markup language (XML) data, extensible hypertext markup language (XHTML) data or other markup language data.

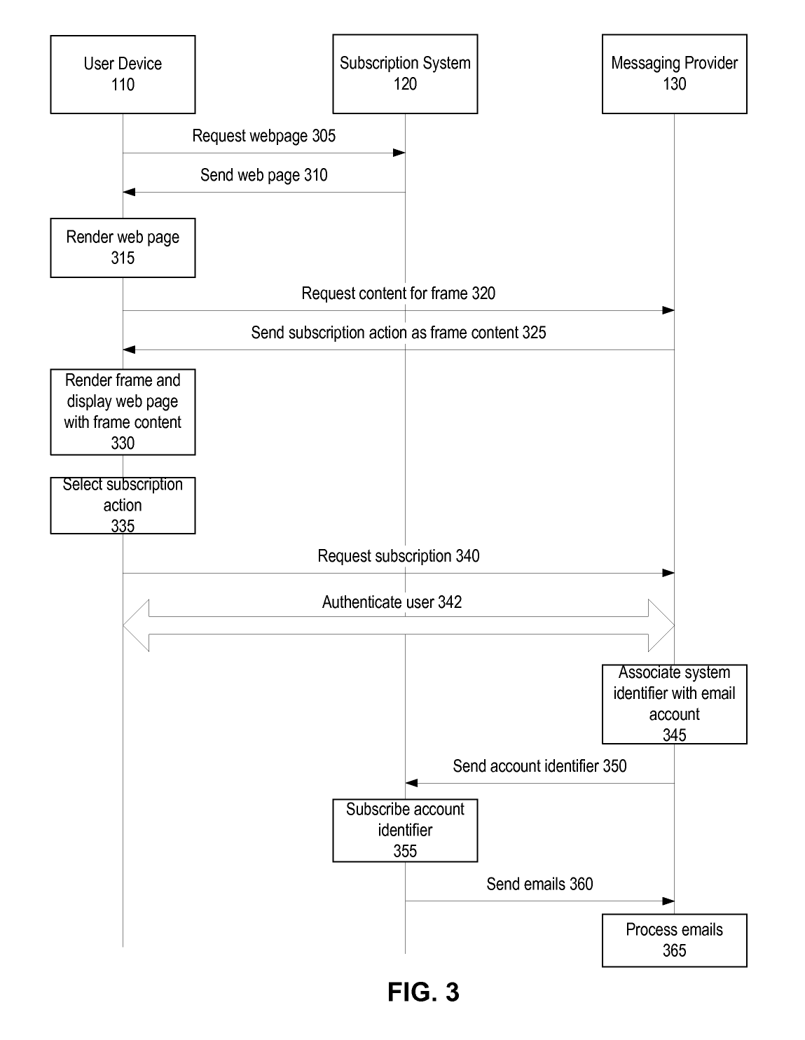

In one embodiment, the user device 110 also includes a cookie 114 including data indicating whether a user of the user device 110 is logged into the messaging provider 130. The cookie 114 indicates whether the user of the user device 110 is involved in an active session where the user device 110 exchanges data with the messaging provider 130, allowing modification of the data communicated from the messaging provider 130 to the user device 110. Use of the cookie 114 in exchanging data between the user device 110, the messaging provider 130 and/or the subscription system 120 is further described below in conjunction with FIG. 3.

The subscription system 120 comprises one or more computing devices that can transmit and receive data via the network 140. In one embodiment, the subscription system 120 is a website comprising one or more web servers. The web servers include one or more web pages 122, which are communicated to the user device 110 via the network 140. The subscription system 120 is separate from the messaging provider 130. For example, the subscription system 120 can be associated with a first domain (e.g., firstdomain.com) while the messaging provider 130 is associated with a separate domain (e.g., seconddomain.com). A web page 122 included in the subscription system 120 comprises a markup language document identifying content and including instructions specifying formatting or presentation of the identified content, as described above.

In one embodiment, a web page 122 includes a widget 124 comprising instructions that, when executed by a browser application 112 of a user device 110, retrieves subscription actions from the messaging provider 130 and displays the subscription actions to the messaging provider 130. In one embodiment, the subscription action is a button within the web page 122 that, when selected, initiates a chain of events for subscribing to the subscription system 120 via the messaging provider 130. Subscribing to a subscription system 120 enables the subscription system 120 to send messages to the subscribing users. For example, messages can include periodic news updates, coupons, or confirmation of activities carried out on the subscription system 120. The contact information (e.g., email addresses, other identifiers, etc) for users that are subscribed to the subscription system 120 is maintained in the subscription database 126.

The messaging provider 130 comprises one or more computing devices and hosts a plurality of message accounts. In one embodiment, the messaging provider 130 is an email provider that hosts a plurality of email accounts. Each email account can be accessed with the proper authentication information, such as a cookie 114 or a user name and password. Each email account includes an email address for receiving and sending messages. The account database 136 maintains a knowledgebase of these email accounts and other metadata associated with the email accounts, which can be updated as new accounts are added or old accounts are removed. The account database 136 also stores a white-list and black-list for each email account that can be used to process incoming messages for that particular email account. Entries in the lists can include, for example, email addresses, domain names (e.g., fakedomain.com), IP addresses, etc.

The message processing module 134 receives messages addressed to email accounts hosted by the messaging provider 130 and processes the messages based on whether the recipient of the message has subscribed to receive messages from the sender of the message. The messages may then be stored into the message data base 138 or output for display. The messages are received from a number of different sources, such as user devices 110, subscription systems 120, or other messaging providers 130 via the network 140. The messaging provider 130 further supports one or more communication protocols such as Hyper Text Transfer Protocol (HTTP), Internet Message Access Protocol (IMAP), Simple Mail Transfer Protocol (SMTP), and Post Office Protocol 3 (POP3). Although shown as two separate databases, in one embodiment, the account database 136 and the message database 138 are a single database.

In one embodiment, the messaging processing module 134 acts as a spam filter that filters messages based on whether the message recipient has subscribed to receive messages from the message sender. For example, if a sender of a message is a subscription system 120 that appears in the recipient's white-list, this is an indication that the user has subscribed to receive messages from this sender. Thus, the message is treated as legitimate mail. If the sender appears in the recipient's black-list, the message is treated as unwanted mail. In other embodiments, the message processing module 134 also considers other factors in processing incoming messages, such as whether incoming emails can be properly authenticated (e.g., using DomainKeys Identified Mail (DKIM)).

In another embodiment, the messaging processing module 134 organizes or categorizes the messages based on whether the message recipient has subscribed to receive messages from the message sender. For example, messages from subscription systems 120 that a user has subscribed to receive message from may be placed into a unique folder that is designated for subscription-based email. Other embodiments including displaying subscription-based email in a unique manner, for example, formatting the email to appear in a different form (e.g., as an advertisement), displaying a visual alert to the user whenever a subscription-based email is received, or presenting the email along with an image that is associated with the source of the email.

The messaging provider 130 also includes a subscription module 132. The subscription module 132 communicates with the user device 110 and subscription system 120 and receives requests to subscribe a user's email account to the subscription system 120. As a result of the request, the subscription module 132 associates the subscription system 120 with the user's email account, for example, by adding the subscription system's domain name to a white-list associated with the email account. The subscription module 132 then notifies the subscription system 120 that the email account has been subscribed to the subscription system 120 so that the user's email account can be added to the subscription database 126. In one embodiment, the subscription module 132 also allows users to terminate their email subscriptions via the messaging provider 130, which causes the subscription module 132 to add the terminated subscription system to a blacklist and/or send an unsubscribe request (e.g., using a List-Unsubscribe header) to an email address associated with the terminated subscription system 120.

The subscription module 132 thus maintains a rich knowledgebase of information about the subscription systems 120 that each email account is subscribed to, which is used by the messaging processing module 134 in processing incoming emails. Managing messaging subscriptions in this manner is beneficial for all entities involved in the messaging system 100. The subscription system 120 benefits because its outgoing messages are no longer at risk of being improperly blocked by the messaging provider 130. The user of the user device 140 benefits because the user's incoming messages from the subscription system 120 are no longer improperly blocked by the messaging provider 130. The messaging provider 130 also benefits because it reduces the guesswork that is typically involved in processing incoming messages.

Structure and Content of a Web Page from an Subscription System

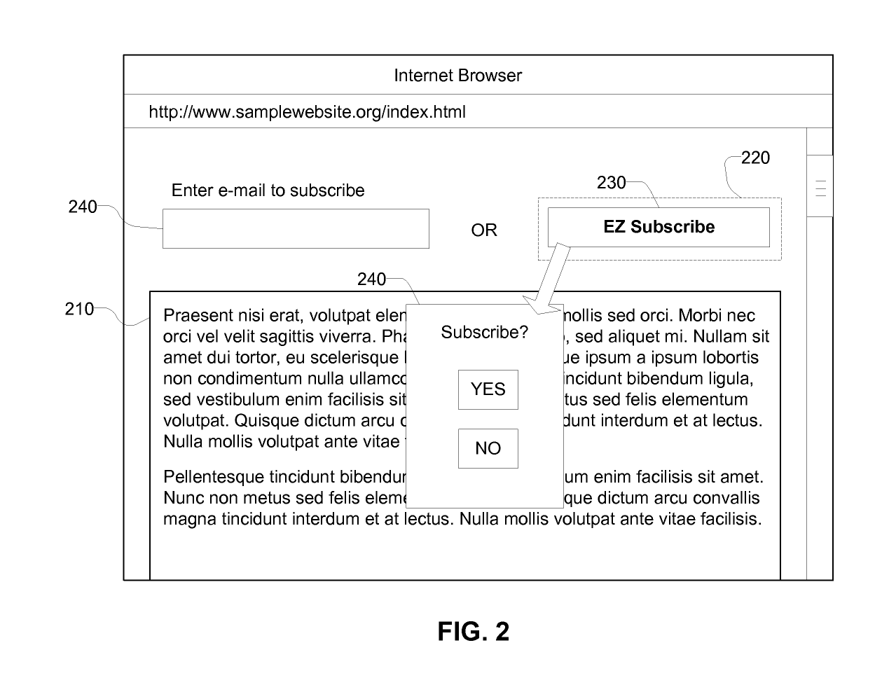

FIG. 2 is one embodiment of a web page 122 of a subscription system 120. The web page 122 includes a frame 220 for interacting with the messaging provider 130. The web page 122 includes content 210 such as text data, video data, image data or any other data for presentation using a browser application 122 operating on a user device 110. The web page 122 also includes one or more instructions describing formatting or presentation of the content 210. When a browser application 112 operating on a user device 110, executes the instructions included in the web page 122, the browser application 112 displays the identified content 210 using the format or presentation described by the web page 122.

In one embodiment, the web page 122 comprises a markup language document 116 that includes the content 210 and the instructions for formatting or presenting the content 210. In various embodiments, the markup language document 116 comprises a data file including extensible markup language (XML) data, extensible hypertext markup language (XHTML) data or other markup language data.

The displayed web page includes functionality allowing a person viewing the web page 122 to subscribe to the subscription system 120. In one embodiment, the displayed web page includes a text box for entering an email address. The email address is transmitted directly to the subscription system 120, which indicates to the subscription system 120 that the email address should be added to the subscription database 126. The web page 122 may additionally include a text box for entering a password in conjunction with the email address.

In one embodiment, the web page includes a frame 220 that calls a Uniform Resource Locator (URL) within a domain associated with the messaging provider 130. The frame 220 is rendered by a browser application 112 operating on a user device 110 executing a widget 124 included in the markup language document 116 encoding the web page 122. The widget 124 comprises one or more instructions that, when executed by a browser application 112, generates the frame 220 within the web page 122. In one embodiment, the frame 220 is an iframe including data obtained from the messaging provider 130.

In one embodiment, the frame 220 includes a subscription button 230 allowing a user of the user device 110 to subscribe to the subscription system 120 providing the web page 122 via the messaging provider 130. Activating the subscription button initiates a chain of events that results in the messaging provider 130 associating the subscription system 120 with the user's email account, for example, by adding the subscription system to a white-list associated with the user's email address. The subscription system 120 is also provided with an identifier for the user's email account, such as an email address, that can be used by the subscription system 120 in sending messages to the user's email account.

In one embodiment, selecting the subscription button 230 opens a new browser window 240. If the user device 110 is logged on to the messaging provider 130 as indicated by a cookie 114, the window 240 includes interactive options (e.g., yes/no buttons) for confirming the subscription. If the user device 110 is not logged into the messaging provider 130, the window includes a prompt (e.g., user name and password prompts) for logging on to the messaging provider 130.

In another embodiment, the web page does not include a separate frame 220. Instead, the subscription button 230 is generated from information stored within the subscription system 120 and is included as part of the web page received from the subscription system 120.

### Managing Messaging Subscriptions

FIG. 3 is an interaction diagram of a process for managing messaging subscriptions, in accordance with an embodiment of the invention. In the embodiment shown by FIG. 3, the subscription system 120 is separate from the messaging provider 130. Initially, a user device 110 requests 305 a web page 122 from the subscription system 120. For example, a user of the user device 110 enters a uniform resource locator (URL) or other identifier associated with the web page 122 into a browser application 112 operating on the user device 110. The browser application 112 identifies the subscription system 120 associated with the received URL or other identifier and requests 305 a web page 122 associated with the received URL or other identifier from the identified subscription system 120.

After receiving the request for the web page 122, the subscription system 120 generates the requested web page 122 using locally-stored data. For example, the subscription system 120 generates a markup language document 116 describing the content and formatting of the web page 122 based on stored data. The web page 122 includes a widget 124 comprising instructions that, when executed by a browser application 112 of a user device 110, retrieves data from the messaging provider 130 and displays the information retrieved from the messaging provider 130. For example, the widget 124 comprises an instruction associated with the messaging provider 130 that generates a frame within the web page 122 that includes information received from the social networking system 130, such as a subscription button.

In one embodiment, the widget 124 also includes parameters for use in subscribing an email address to the subscription system 120 via a messaging provider 130. In one embodiment, the parameters include a system identifier that can be used to identify emails originating from the subscription system 120. Examples of system identifiers include domain names (e.g., vmail.org), email addresses (e.g., coupons@vmail.org), or Internet Protocol (IP) addresses. In one embodiment, the parameters include contact information for enabling the messaging provider 130 to notify the subscription system 120 that a new email address should be subscribed to the subscription system 120. For example, the contact information can be a callback URL of a webpage hosted by the subscription system 120 or information about an API in the subscription system 120 that, when accessed by the messaging provider 130, adds an email address to the subscription database 126. Although not explicitly shown in FIG. 3, the parameters may be passed between the user device 110, subscription system 120, and messaging provider 130 along with the communications shown in the figure. In one embodiment, the parameters are passed using various techniques such as a query strings embedded in http requests.

The subscription system 120 then sends 310 the markup language document 116 describing the generated web page 122 and including the widget 124 to the user device 110 through the network 140. After receiving the markup language document 116, the browser 112 renders 315 the web page 122 based on the content and formatting instructions included in the markup language document 116. In addition to rendering 315 the web page 122, the browser 112 in the user device 110 executes the widget 124 to create a frame in the web page 122. Execution of the widget 124 also causes the browser 112 to request 320 content from the messaging provider 130 for inclusion in the frame. In one embodiment, the subscription parameters are included along with the request 320 for content.

Responsive to receiving the request from the browser 112, the messaging provider 130 generates subscription actions for the frame. In one embodiment, the subscription action comprises a subscription button or subscription link for subscribing to the subscription system 120 via the messaging provider 130, similar to the subscription button 230 in FIG. 2.

The messaging provider 130 then sends 560 the subscription actions to the user device 110. The browser application 112 included on the user device 110 renders 330 the frame using the subscription actions received from the social networking system 130 and displays 330 the web page 122 and the frame, with the subscription actions displayed in the frame.

In other embodiments, the web page 122 may not include a widget or frames. Instead, the subscription action is included in the content of the web page 122 itself. The subscription action is generated by the subscription system 120 based on subscription parameters stored in the subscription system 120. Alternatively, the subscription action is retrieved by the subscription system 120 from the messaging provider 130 through an Application Programming Interface (API) of the messaging provider 130. The subscription action is placed somewhere within the content of the web page 122. The web page 122, which includes the subscription action, is sent 310 to the user device 110 in response to a request 305 for a web page 122. For example, referring back to FIG. 2, a web page 122 may include a subscription button 230 that is not located within a frame 230.

Referring again to FIG. 3, when a subscription action is selected 335 by a user of the user device 110 interacting with a subscription action, a subscription request is transmitted 340 to the messaging provider. The subscription request may include parameters such as the system identifier and callback URL of the subscription system 120. The user device 110 and the messaging provider 130 then engage communications to authenticate 342 a user's email account with the messaging provider 130. In one embodiment, the user device 110 provides a cookie 114 with the subscription request 340. The cookie 114 indicates whether the user of the computing device 110 is also user of the messaging provider 130 (e.g., whether the user has a valid account with the messaging provider 130). If the user of the computing device 110 is a user of the messaging provider 130, the cookie 114 may contain information indicating whether the user is logged into the messaging provider 130 (e.g., whether the user has a current valid session with the messaging provider 130). Sending the cookie 114 allows the messaging provider 130 to authenticate the user session. In other embodiments, other methods of user or session authentication are also possible. For example, a physical token or a login name/password may be used to authenticate a user session.

Once the user's email account is authenticated, the messaging provider 130 asks the user of the user device 110 to confirm the subscription, for example, by sending a webpage that includes “yes” and “no” buttons. The user device 110 receives a user input confirming the subscription, such as a user selecting the “yes” button, which is then sent to the messaging provider 130. Alternatively, the messaging provider 130 may proceed without providing any confirmation to the user once the user's credentials have been authenticated.

The messaging provider 130 associates 345 the user's email account with the system identifier (e.g., email address or domain name) of the subscription system 120. In one embodiment, the system identifier is obtained from a parameter received in conjunction with the subscription request 340. In one embodiment, associating comprises adding the system identifier to a white-list that is maintained for the user's email account. The messaging provider 130 thus maintains an up-to-date list of subscription systems 120 that each email account is subscribed to, enabling the messaging provider 130 to more accurately process incoming messages. Other embodiments include displaying a confirmation window, such as window 250 in FIG. 2, before the request 340 is accepted by the messaging provider.

The messaging provider 130 then notifies the subscription system 120 that the user has subscribed to the subscription system 120 by sending 350 an account identifier for the user's email account to the subscription system 120. In one embodiment, the account identifier is delivered to a callback URL received as a parameter in the subscription request 340. The account identifier is any type of identifying information that can be used by the subscription system 120 to deliver messages to the user's email account. In one embodiment, the identifier is the user's email address. In another embodiment, the identifier is a substitute for the user's actual email address, such as a reply handler email address. When messages are received by the messaging provider 130 that are intended for the substitute email address, they are automatically forwarded to the user's actual email address. In another embodiment, the identifier can be other than an email address, such as a unique identifier maintained by the messaging provider in association with the user's email account.

In another embodiment, the messaging provider 130 does not actively notify the subscription system 120 that a user has subscribed to the subscription system 120. Instead, the messaging provider 130 maintains an Application Programming Interface (API) that allows the subscription system 120 to access information from the messaging provider 120 by calling one or more APIs. Through the APIs, the subscription system 120 can periodically poll the messaging provider 130 for email accounts that are subscribed to the subscription system 120. In response, the messaging provider 130 sends 350 account identifiers for subscribed email accounts to the subscription system 120.

Upon receiving an account identifier from the messaging provider 130, the subscription system 120 subscribes 355 the user to the subscription system 120 using the account identifier. For example, the subscription system 120 may add the account identifier to a mailing list that is stored in the subscription database 126, which is then used for sending 360 periodic messages to users that appear in the list. As another example, the user may have a profile stored within the subscription database 126, and the subscription system 120 may store the account identifier in association with the user's profile. When the subscription system needs to contact the user, it retrieves the account identifier from the user's profile and sends 360 a message (e.g., news updates, bank statements, confirmation emails, etc) to the user using the account identifier.

The messaging provider 130 receives incoming messages addressed to email accounts hosted by the messaging provider 130. Emails may be received from various sources such as subscription systems 120, user devices 110, or other messaging providers (not shown). Upon receiving the messages, the messaging provider 130 processes 365 the incoming messages. In one embodiment, each message is analyzed to identify the sender and intended recipient (e.g., an email address) of the message. The message sender is compared to the recipient's white-list to determine how to handle the message. For example, if the sender appears in the recipient's white-list, the message may be deemed not to be spam and allowed to pass into the recipient's inbox. However, if the sender appears in the recipient's black-list, the message is marked as spam. In other embodiments, whether a sender appears in the white-list is only one of many factors used in processing 365 an email. Other factors may include content-based analysis of the email to detect malicious content, reputation based analysis that considers whether the source domain has been blacklisted by other users, or authentication based analysis to ensure that the sender's name is not spoofed.

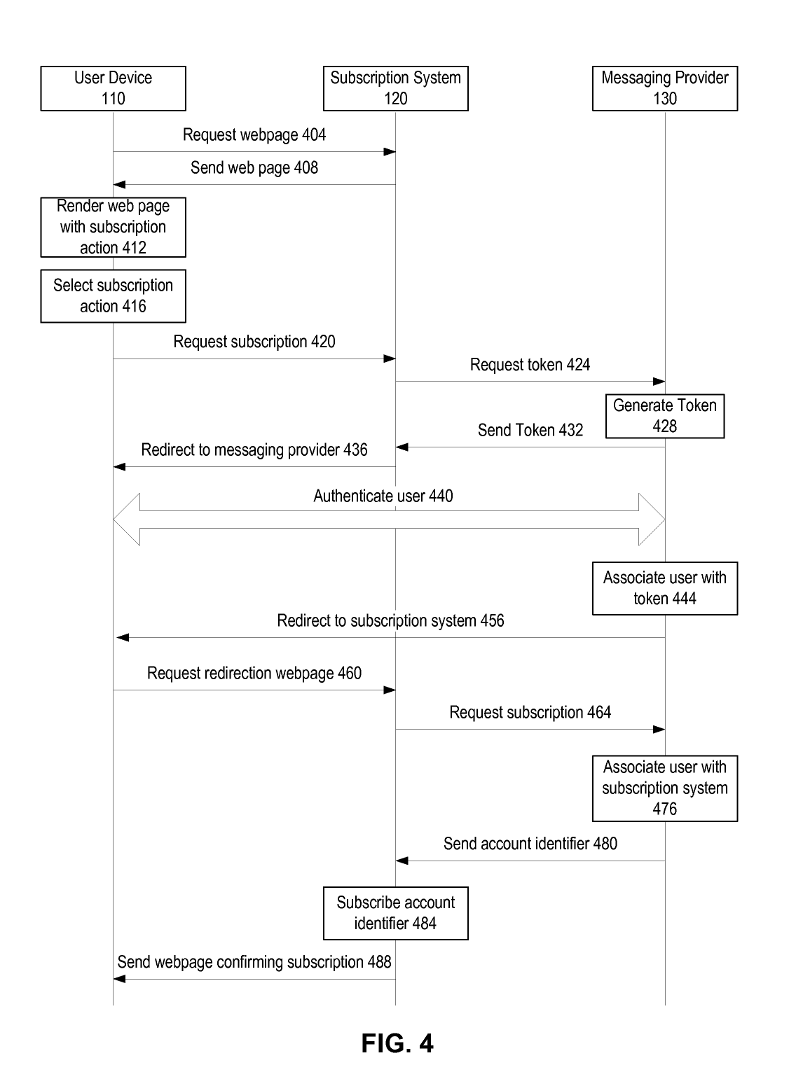

FIG. 4 is an interaction diagram of a process for managing messaging subscriptions, in accordance with another embodiment of the invention. Although similar to FIG. 3, this embodiment introduces a token that is passed between the user device 110, the subscription system 120, and the messaging provider 130. The messaging provider 130 creates then token, a user of the user device 110 authenticates the token, and the subscription system 120 uses the token to obtain an account identifier for the user from the messaging provider 130.

Initially, the user device 110 requests 404 a web page from the subscription system 120. The subscription system 120 generates the requested web page 122 using locally-stored data and sends 408 the web page to the user device. The web page includes a subscription action, such as a button or http link for subscribing to the subscription system 120 via the messaging provider 130. For example, referring back to FIG. 2, the subscription action can be similar to button 220. In one embodiment, the web-page does not include a widget and the subscription action is generated from data within the subscription system 120.

The user device then renders 412 the web page and displays the web page, which includes the subscription action, to a user of the user device 110. The user device 110 receives a user input selecting 416 the subscription action. For example, the user may select the subscription action with mouse or keyboard input. The subscription action generates a subscription request that is sent 420 to the subscription system 120, indicating to the subscription system 120 that the user wants to be added to the subscription system 120.

Upon receiving the subscription request, the subscription system 120 requests 424 a token from the messaging provider. In one embodiment, the token is a unique string of letters and numbers that cannot easily be guessed. The token is used to track the state of the messaging system 100 and is passed between the various entities of the system, such as the user device 110, the subscription system 120, and the messaging provider 130. If not used within a certain period of time, the token expires and a new token must be requested. In one embodiment, the token request 424 also includes other parameters such as a callback URL, which is a URL hosted by the subscription system. The callback URL is used in a later step in order to complete the process of subscribing the user to the subscription system 120 via the email provider 130.

After receiving the token request 424, the messaging provider responds by generating 428 the token and sending 432 the token to the subscription system 120. The subscription system 120 receives the token and redirects 436 the user device 110 to the messaging provider 436. In one embodiment, the user device 110 is redirected to a URL hosted by the messaging provider 436. The redirection URL is determined from a parameter received by the subscription system 120 from the messaging provider 130 along with the token.

The user device 110 and the messaging provider 130 then engage in a series of communications to authenticate 440 a user's email account with the messaging provider 130. In one embodiment, the user device 110 requests the redirection URL from the messaging provider 436 and provides a cookie 114 with the request. The cookie 114 indicates whether the user of the computing device 110 is also user of the messaging provider 130 (e.g., whether the user has a valid account with the messaging provider 130). If the user of the computing device 110 is a user of the messaging provider 130, the cookie 114 may contain information indicating whether the user is logged into the messaging provider 130 (e.g., whether the user has a current valid session with the messaging provider 130). Sending the cookie 114 allows the messaging provider 130 to authenticate the user session. In other embodiments, other methods of user or session authentication are also possible. For example, a physical token or a login name/password may be used to authenticate a user session. In one embodiment, the communications between the user device 110 and the messaging provider 130 also include the token as parameter that is passed along with each of these communications.

Once the user's email account is authenticated, the messaging provider 130 asks the user of the user device 110 to confirm the subscription, for example, by sending a webpage that includes “yes” and “no” buttons. The user device 110 receives a user input confirming the subscription, such as a user selecting the “yes” button, which is then sent to the messaging provider 130. Alternatively, the messaging provider 130 may proceed without providing any confirmation to the user once the user's credentials have been authenticated. In either situation, the messaging provider 130 associates 444 the token with the user's email account, thereby indicating to the messaging provider 130 that the token has been authenticated for use with the user's email account.

The messaging provider 130 next redirects 456 the user device 110 to the subscription system 120. In one embodiment, the messaging provider 130 redirects the user device 110 to the callback URL originally provided by the subscription system 130 in conjunction with the token request 424. The user device 110 requests 460 a webpage from the subscription system 120 based on the redirection address. The subscription system 120 then sends 464, to the messaging provider 130, a request 120 to subscribe the user's email account to the subscription system. In one embodiment, the request includes parameters such as the token and a system identifier. As previously described, the system identifier can be used to identify emails originating from the subscription system 120. Examples of system identifiers include domain names (e.g., vmail.org), email addresses (e.g., coupons@vmail.org), or Internet Protocol (IP) addresses. In other embodiments, the system identifier may have been separately provided by the subscription system 120. For example, the subscription system 120 may have provided the system identifier 120 at the time of the token request 424.

The messaging provider 130 associates 476 the user's email account with the received system identifier (e.g., email address or domain name). The user's email account can be identified from the pre-existing relationship, identified in step 444, between the user's email account and the token. In one embodiment, associating comprises adding the system identifier to a white-list of system identifiers that is maintained in association with the user's email account. In this manner, the messaging provider 130 maintains an up-to-date list of subscription systems 120 that each email account is subscribed to, thereby enabling better management (e.g., by categorizing and filtering) of incoming messages.

The messaging provider 130 subsequently sends 480 an account identifier for the user's email account to the subscription system 120. Upon receiving the account identifier, the subscription system 120 subscribes 484 the user to the subscription system 120 using the account identifier. For example, the subscription system 120 may add the account identifier to a mailing list that is stored in the subscription database 126, which is then used for sending periodic messages to users that appear in the list. As another example, the user may have a profile stored within the subscription system 120, and the subscription system 120 may store the account identifier in association with the user's profile. When the subscription system needs to contact the user, it retrieves the account identifier from the user's profile and sends a message (e.g., news updates, bank statements, confirmation emails, etc) to the user using the account identifier.

The subscription system 120 then sends 488 a web page to the user device 110 confirming that the subscription request was successful. Similar to steps 360 and 365 in FIG. 3, the subscription system 120 also sends emails directed to email accounts hosted by the messaging provider 130, and the messaging provider 130 receives and processes these emails.

For the purposes of clarity, the foregoing embodiments in FIG. 1-4 have been primarily described with respect to a messaging system 100 for sending and receiving email messages. In another embodiment, the principles described herein can be applied to a messaging system 100 that is designed to handle any type of electronic message format, such as Short Message Service (SMS) messages, text messages, chat messages, email messages, etc. Additionally, the messaging system 100 may be capable of handling a mix of different message types, such as both email messages and SMS messages.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for managing email subscriptions, the method comprising:
receiving, at a messaging provider that hosts a user's email account, a request to subscribe the user's email account to a system that is external to the messaging provider, the request generated based on the user's interaction with the system;
associating the system with the user's email account to indicate to the messaging provider that the user has subscribed to receive messages from the system; and
communicating an account identifier for the user's email account to the system, the account identifier for use by the system in sending messages to the user's email account.

2. The method of claim 1, further comprising:
receiving one or more email messages addressed to an email address of the user's email account; and
for each received message, processing the message based at least in part on whether a sender of the message is a system that the user has subscribed to receive messages from.

3. The method of claim 1, wherein receiving a request to subscribe the user's email account to a system comprises receiving the request from the system.

4. The method of claim 1, wherein receiving a request to subscribe the user's email account to a system comprises receiving the request from a user device.

5. The method of claim 1, wherein the system comprises a website that hosts one or more web pages and the interaction with the system comprises at least one of a request to access the one or more web pages or a selection of a subscription action presented by the one or more web pages.

6. The method of claim 1, wherein associating the system with the user's email account comprises adding the system to a whitelist maintained by the messaging provider for the user's email account.

7. The method of claim 1, further comprising receiving a system identifier for the system, and wherein associating the system with the user's email account comprises associating the system identifier with the user's email account.

8. The method of claim 7, wherein the system identifier comprises a domain name associated with the system.

9. The method of claim 7, wherein the system identifier comprises an email address associated with the system.

10. The method of claim 1, wherein the account identifier comprises an email address associated with the email account.

11. The method of claim 2, wherein processing the message further comprises processing the message based on whether the message can be authenticated.

12. A method for managing messaging subscriptions, the method comprising:
receiving, at a messaging provider that hosts a user's message account, a request to subscribe a user's message account to a system that is external to the messaging provider, the request generated based on the user's interaction with the system;
associating the system with the user's message account to indicate to the messaging provider that the user has subscribed to receive messages from the system; and
communicating an account identifier for the message account to the system, the account identifier for use by the system in sending messages to the user's message account.

13. The method of claim 12, further comprising:
receiving one or more messages addressed to a user's message account; and
for each message, processing the message based at least in part on whether a sender of the message is a system that the user has subscribed to receive messages from.

14. The method of claim 12, wherein the one or more messages comprise at least one of short message service (SMS) messages, text messages, email messages and chat messages.

15. The method of claim 12, wherein the one or more messages comprise a plurality of messages, the plurality of messages including at least two different types of messages.

16. A method for managing messaging subscriptions, the method comprising:
receiving, at a system, a request from a user device for a web page hosted by the system;
sending the web page to the user device, the web page when displayed on the user device comprises a subscription action for subscribing to receive messages from the system via a messaging provider, the messaging provider being external to the system and hosting a user's message account;
receiving an account identifier for the user's message account from the messaging provider, the account identifier received as a result of the user selecting the subscription action; and
subscribing the user to receive messages from the system using the account identifier.

17. The method of claim 16, further comprising sending messages to the user using the account identifier.

18. The method of claim 17, wherein the messages comprise at least one of short message service (SMS) messages, text messages, email messages and chat messages.

19. The method of claim 16, wherein the system comprises a website.

20. The method of claim 16, wherein the account identifier comprises an email address associated with the message account.
